(19) United States
(12) Patent Application Publication
(10) Pub. No.: US 2005/0086210 A1
(43) Pub. Date: Apr. 21, 2005

(54) Method for retrieving data, apparatus for retrieving data, program for retrieving data, and medium readable by machine

(76) Inventors: Kenji Kita, Tokushima City (JP); Masami Shishibori, Tokushima City (JP); Shun'ichiro Oe, Tokushima City (JP)

Correspondence Address: SMITH PATENT OFFICE, 1901 PENNSYLVANIA AVENUE N W, SUITE 200, WASHINGTON, DC, 20006, US

(21) Appl. No.: 10/811,953

(22) Filed: Mar. 30, 2004

(30) Foreign Application Priority Data
Jun. 18, 2003 (JP) 2003-174078

(51) Int. Cl. G06F 7/00

(52) U.S. Cl. 707/3

(57) ABSTRACT

A method for retrieving data from multidimensional data includes providing a plurality of vectors having feature values in the multidimensional data. A specified retrieving condition is transformed into a retrieving query vector having a dimension equal to a dimension of the multidimensional data. Distances between the retrieving query vector and potential vectors to be retrieved are calculated. The process is stopped and skips calculating a distance when a cumulative value is greater than a maximum value. The method also retains the distance calculated when the cumulative value is less than the maximum value. The maximum value is replaced with the distance calculated, when the distance is less than the maximum value. The method then outputs the retained multidimensional data after the retaining and replacing steps. An apparatus, computer program and machine readable medium related to the method are also discussed.

### BACKGROUND OF THE INVENTION

1. Field of the Invention

The present invention relates to a method for retrieving data, an apparatus for retrieving data, a program for retrieving data, and a medium readable by a machine, which retrieve multidimensional data. Particularly the present invention relates to a method for retrieving data, an apparatus for retrieving data, a program for retrieving data, and a medium readable by a machine applicable to data matching such as image retrieving, video retrieving, and music retrieving, for example.

2. Discussion of the Related Art Recently, electronic calculators, such as a computer, have become more powerful and available at a lower cost, and further have large-capacity memories. For this reason, the electronic information and information technology have spread quickly. As a result, the electronic data is increasingly used. As compared with data in paper, the electronic data can be easily reproduced, can be easily processed, and can be easily shared. In terms of retrieval, electronic data is advantageous. In particular, recently, the Internet has become popular and not only the document but multimedia data, such as image data, video data, voice data, and music data, are frequently used. Accordingly, techniques, such as retrieval of desired data and data similar to this classification and organization become more important. Hereinafter, data matching includes retrieval of multimedia data, data mining, pattern recognition, machine learning, computer vision, statistical data analysis, etc.

When a computer performs data matching, multimedia data can be represented by a feature vector in the computer. The feature vector can be used also when data similar to a specified retrieving condition (input query) is retrieved from a database. FIG. 1 is an example showing multimedia-contents retrieval using the feature vector. When the feature vector is specified as a retrieving condition for similar retrieval, in order to perform the retrieval process, distances between a vector of the retrieving condition and vectors in the database are calculated. Then, data with a small distance are outputted as a result of the retrieval. Thus, retrieving vectors with small distances to the vector specified as the criterion from the database is referred to as a nearest neighbor search. In the nearest neighbor search, a plurality of features are represented by a multidimensional vector. The similarity of data is determined based on the distance between vectors. For example, in document retrieval, documents and the retrieving condition can be represented by a weighted vector of an index word. Moreover, in retrieving a similar image, the image data is represented by a feature vector, such as a color histogram, a texture feature, or a shape feature.

Linear retrieval (linear search) is known as such a retrieval of similar contents based on a feature vector. In linear retrieval, feature vectors of all data in the database are sequentially compared with the vector specified by the retrieving condition. For this reason, an amount of calculation proportional to the scale of the database is required. The amount of calculation increases the processing load of the computer, and the necessary processing time. Accordingly, a large-scale database seriously affects processing efficiency of the retrieving system. Therefore, development of a multidimensional indexing technique for performing the nearest neighbor search with a high efficiency has been aggressively studied as an important subject. See Japanese Laid-Open Publication Kokai No. 2002-318818; and Japanese Laid-Open Publication Kokai No. 2001-209651.

However, no effective methods for retrieving for multidimensional data have been developed yet. Generally the number of dimensions of the feature vector is very high. Therefore, it is not easy to develop an efficient multidimensional indexing technique in a high-dimensional space.

For example, R-tree, SS-tree, SR-tree, and so on, are proposed as multidimensional indexing techniques in Euclidean space. Moreover, VP-tree, MVP-tree, M-tree, and so on, are proposed as indexing techniques for more general metric space. In such indexing techniques, multidimensional space is hierarchically divided. Thereby, these indexing techniques perform retrieval by limiting the retrieval range. If the retrieval range is limited, the amount of calculation can be reduced according to this limitation. However, in high-dimensional space, the ratio of the distances of the nearest and farthest points to a given point is almost 1 for a wide variety of data distributions. This phenomenon is known as “curse of dimensionality”. For this reason, it is difficult to limit the area to be retrieved because of the “curse of dimensionality” phenomenon. Consequently, there is a problem that the amount of calculations should be similar to the linear retrieval method.

In order to solve the above problem in high-dimensional space, approximation methods of the nearest neighbor search have been studied. For example, techniques for indexing points in the high-dimensional space are proposed by using an approximation retrieval technique based on the hashing method, the space-filling curve, or the like. However, these techniques are not in practical use.

On the other hand, in cross-media information retrieval, where various kinds of media data are mixed, it is difficult to obtain desired search results using one retrieving step. In order to obtain desired search results, users often perform two or more retrieving steps. Therefore, in cross-media information retrieval, the numbers of times for performing the nearest neighbor search based on the feature vector should increase. Especially, in such a case, high-speed retrieval is required.

Meanwhile, the inventors of the present invention have developed a method for a high-speed nearest neighbor search in high-dimensional data by using one-dimensional self-organizing map (Japanese Published Patent Application No. 2002-204306). In this method, the one-dimensional self-organizing map is used for an approximation method of the nearest neighbor search. The efficiency of the access to the secondary storage device is improved. This development achieves high-efficiency and high-speed data matching. However, this method is an approximation technique. Accordingly, there is a problem that some errors in the search results cannot be eliminated.

Additionally, conventional research tends to focus on methods other than the linear retrieval method, which takes a long time. Therefore, improvement and reexamination of the simple and essential linear search method is not studied very much.

The present invention is devised to solve this problem. The main object of the present invention is to provide an apparatus for retrieving data, a method for retrieving data, a program for retrieving data, and a medium readable by a machine, that exactly retrieves multidimensional data at a higher-speed than the conventional methods and apparatus. The above and further objects and features of the invention will be more fully be apparent from the following detailed description with the accompanying drawings.

### SUMMARY OF THE INVENTION

To solve the above problem, a method for retrieving data according to the present invention comprises the steps of providing a plurality of vectors having feature values in the multidimensional data; transforming a specified retrieving condition into a retrieving query vector having a dimension equal to a dimension of the multidimensional data; calculating distances between the retrieving query vector and potential vectors to be retrieved, the step of calculating distances includes calculating a distance between the retrieving query vector and a potential vector to be retrieved by serially adding a value corresponding to a subsequent component of each vector for a subsequent dimension to a cumulative value when the cumulative value is less than the maximum value; stopping the step of serially adding a value and skipping the step of calculating a distance when the cumulative value is greater than the maximum value; retaining the distance calculated in the step of calculating when the cumulative value is less than the maximum value; replacing the maximum value with the distance calculated in the step of calculating, when the distance is less than the maximum value; and outputting the multidimensional data retained in the step of retaining the distance after the steps of retaining and replacing.

In addition, a method for retrieving related data from multidimensional data may also comprise the steps of providing a plurality of vectors having feature values in the multidimensional data; transforming the specified retrieving condition into a retrieving query vector having a dimension equal to a dimension of the multidimensional data; calculating distances between the retrieving query vector and potential vectors to be retrieved, the step of calculating distances includes calculating a distance between the retrieving query vector and a potential vector to be retrieved by serially adding a value corresponding to a subsequent component of each vector for a subsequent dimension to a cumulative value when the cumulative value is less than a maximum value; stopping the step of serially adding a value and skipping the step of calculating a distance when the cumulative value is greater than the maximum value; retaining the distance calculated in the step of calculating when the cumulative value is less than the maximum value; replacing the maximum value with the distance calculated in the step of calculating, when the distance is less than the maximum value; and outputting the multidimensional data retained in the step of retaining the distance.

Further, the method for retrieving data may further comprise the step of sorting components of the potential vectors to be retrieved based on variance values of components of the potential vectors to be retrieved for respective dimensions before the step of calculating a distance, wherein the step of calculating a distance starts by adding a component of the dimension having a greater variance value.

Furthermore, the method for retrieving data according to the present invention further comprises the step of transforming a coordinate system of the vector previously based on a principal component analysis, or a Karhunen-Loeve transform, before calculating the distance between the retrieving query vector and the potential vectors to be retrieved, wherein the calculating step is performed based on the vector obtained in the step of transforming.

Additionally, in the method for retrieving data according to the present invention, the vectors to be retrieved are stored in a local database or a database connected to a network, and the step of retrieving data is performed for the data stored in the database.

Furthermore, in the method for retrieving data according to the present invention, the data to be retrieved may include any of the following: document data, image data, which includes still image or video image, voice data, and music data, or any combination of them.

Furthermore, in the method for retrieving data according to the present invention, includes retrieving data for recognizing an image pattern.

In addition, an apparatus for retrieving data from a database having multidimensional data including a plurality of vectors having feature values, comprises an input portion for specifying a retrieving condition for retrieving data from the database storing the multidimensional data and for transforming the retrieving condition into a retrieving query vector having a dimension equal to a dimension of the multidimensional data; a calculating portion for calculating a distance between the retrieving query vector and a potential vector to be retrieved by serially adding a value corresponding to a subsequent component of each vector for a subsequent dimension to a cumulative value; a memory portion for retaining a plurality of distances calculated by the calculating portion; an extracting portion for extracting a maximum value of the plurality of the distances retained by the memory portion; an updating portion for updating the memory portion by replacing the maximum value with the distance calculated by the calculating portion when the calculated distance is less than the maximum value extracted by the extracting portion; and calculation stopping portion comparing the cumulative value with the maximum value during calculating the distance between the retrieving query vector and the potential vectors to be retrieved by serially adding a value corresponding to a subsequent component of each vector for a subsequent dimension to the cumulative value, the calculation stopping portion stopping the addition of the subsequent component of the vector and skipping a calculation of the distance of a subsequent component of the vector, when the cumulative value is greater than the maximum value.

Additionally, a program for retrieving data from a database having multidimensional data including a plurality of vectors having feature values is disclosed. The program comprises means for transforming a specified retrieving condition into a retrieving query vector having a dimension equal to a dimension of the multidimensional data; means for calculating distances between the retrieving query vector and potential vectors to be retrieved including means for calculating a distance between the retrieving query vector and a potential vector to be retrieved by serially adding a value corresponding to a subsequent component of each vector for a subsequent dimension to a cumulative value when the cumulative value is less than a maximum value; means for stopping the means for calculating and skipping calculating a distance when the cumulative value is greater than the maximum value; means for retaining the distance calculated by the means for calculating when the cumulative value is less than the maximum value; means for replacing the maximum value with the calculated distance for the potential vector to be retrieved when the distance is less than the maximum value; and means for outputting the multidimensional data retained in the means for retaining.

Moreover, the means for retaining the distance can include means for retaining the distance when the distance is within a predetermined range.

Furthermore, a medium readable by a machine such as computer according to the present invention stores any of the above programs for retrieving data. The medium includes a magnetic disk, an optical disc, a magneto-optical disc and a semiconductor memory, such as CD-ROM, CD-R, CD-RW, a flexible disk, a magnetic tape, MO, DVD-ROM, DVD-RAM, DVD−R, DVD+R, DVD−RW, DVD+RW, Blu-ray, or AOD (HD DVD), and other mediums that can store the program. The program includes not only a program provided in the media but also a program capable of being downloaded through a public line such as the Internet. Each means in the program can be performed by program software capable of running on a computer. In addition, each means in the program may be performed by hardware such as a predetermined gate array (FPGA, ASIC) or by a mixed system of program software and a partial hardware module, which plays a part in the role of the hardware.

In the method for retrieving data, the apparatus for retrieving data, the program for retrieving data, and the medium readable by a machine according to the present invention, it is possible to achieve extremely high-speed retrieval. An amount of calculation for nearest neighbor search is 1/20 to 1/50 of the time needed compared with the conventional simple linear retrieving algorithm. In addition, since this method is not an approximation method, this method can provide exact results of the retrieval process. Since the result does not include errors, it provides high reliability for data retrieval. Moreover, additional hardware is not required. Accordingly, this method can be easily applied to an existing retrieving apparatus at a low cost.

### BRIEF DESCRIPTION OF THE DRAWINGS

FIG. 1 is a schematic illustration showing one example of the multimedia-contents retrieval method and apparatus using a feature vector.

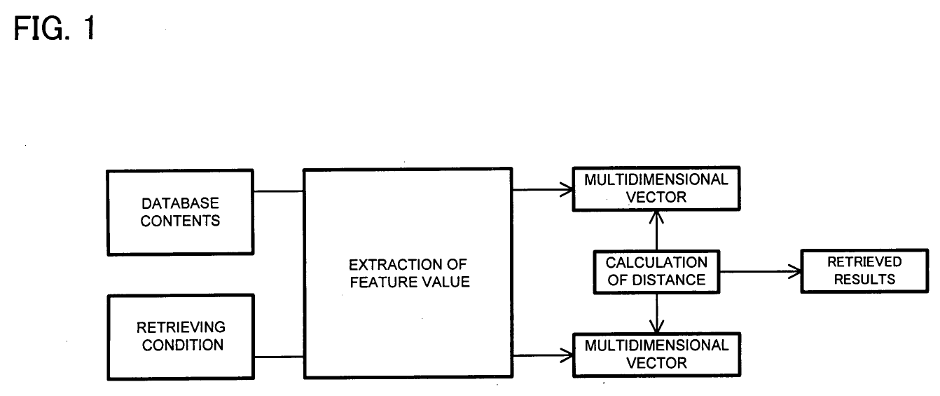

FIG. 2 is a block diagram showing a data-retrieving apparatus according to one embodiment of the present invention.

FIG. 3 is a flowchart showing one example of the linear retrieval procedure.

FIG. 4 is a flowchart showing a part of the data retrieval process according to other embodiments of the present invention.

FIG. 5 is a subsequent flowchart showing another portion of the flowchart shown in FIG. 4.

FIG. 6 is a graph showing results of the data retrieval methods according to embodiments of the present invention and methods using comparative examples.

### DETAILED DESCRIPTION OF THE PREFERRED EMBODIMENTS

The following description will describe the embodiments according to the present invention with reference to the drawings. In the present invention, multimedia data including document data such as the text and image data are used. The image data is a still image or a video image. The music data is a musical performance, and the voice data is a public performance or a speech. These data can be used as data to be retrieved during data retrieval. In addition, the data retrieval method includes retrieval of multimedia data, data mining, pattern recognition, machine learning, computer vision, statistical data analysis, and so on in a database of one kind of data such as document data or image data, or a mixed database having two or more kinds of data. Data mining refers to the process for automatically detecting useful information from many kinds and a large amount of data using a statistical or a mathematical technique. Useful information includes a tendency, a pattern, a correlation, a convention of data, for example, a statistical data analysis, a decision tree, a neural network, and so on can be used in data mining. In these techniques, the data is generally represented by a multidimensional vector. In such a case, the data retrieval of the present invention is used to perform processing for retrieving data similar to certain particular data.

Feature Vector

In the present invention, various feature vectors can be selected according to the kind of electronic data (media contents). In the retrieval of various media contents, when the contents of the whole media, or data itself, included in the database are used, the processing should be performed for an extremely large amount of data. Accordingly, feature values, are used which remarkably represent details of the data contents. The feature values are represented as a feature vector in a multidimensional vector form. Here, multi-dimension is explained. When data has n properties of attributions and is represented by n attribute values in a single row or a single column, this data is referred to as n-dimensional data. Each data is positioned in n-dimensional space. Generally, when n is large, the data is referred to as multidimensional data. Retrieving each data is performed by retrieving in the multidimensional space.

In the document contents, the word which remarkably represents details of the document is extracted from the words in the document as an index word. The frequency of the index word is used as a feature value representing the document contents.

Color information, shape information, and texture information can be used as feature values representing the image contents. The color distribution in an image is transformed into a histogram according to an RGB color system, a CIE Lab color system, or the like. The transformed multidimensional vector is used as color information. Shape information and texture information are multidimensional vectors, which include values obtained according to the frequency resolution by Wavelet transform, etc.

In the music content, time varying of pitch or distribution of pitch difference can be represented by a multidimensional vector based on the pitch of each tone of the music. The multidimensional vector is used as the feature values representing the music content.

Additionally, it should be appreciated that the technique for retrieving data with similar contents capable of representing the contents feature values is not specifically limited to the above fields of multimedia information retrieval. The technique is widely used in many fields such as data mining, pattern recognition, machine learning, computer vision, and statistical data analysis. In these fields, values of various attributions of data are represented by a multidimensional vector as features of the data.

In the present invention, a method for retrieving data, an apparatus for retrieving data, a program for retrieving data, and a medium readable by a machine are not specifically limited to a system for retrieving data itself, and are not specifically limited to an apparatus or method for processing such as the inputting, outputting, displaying, calculating, and communicating by hardware. An apparatus or method for processing by software is included within the scope of the present invention. At least one of a method for retrieving data, an apparatus for retrieving data, a program for retrieving data, and a medium readable by a machine of the present invention includes a general-purpose or a special-purpose computer, a work station, a terminal, a portable electric device, a cellular phone such as PDC, CDMA, W-CDMA, FOMA (registered trademark), GSM, IMT2000 and the 4th generation, PHS, PDA, a pager, a smart phone, and other electronic devices, which have a general-purpose circuit or computer with software, program, plug-in, object, library, applet, compiler, or the like, to perform data retrieval or some processing related to data retrieval. Moreover, in the present invention, the program itself is included as an apparatus for retrieving data.

Connection and Communication Form Terminals, such as a computers, used in embodiments of the present invention, can communicate by electrically connecting through a serial connection or a parallel connection, such as IEEE 1394, RS-232x, RS-422, USB, serial ATA, or network of 10 BASE-T, 100 BASE-TX, or 1000 BASE-T. The other peripheral devices, such as a computer for operation, control, input-output, the display, various processing devices, or a printer, which are connected to the server or these terminals, can also communicate in a similar manner. The connection is not limited to a physical connection using a cable. A wireless LAN, such as IEEE802, 11× and OFDM form and a wireless connection, such as Bluetooth, using electric waves, infrared radiation, optical communication, or the like, may be used. Furthermore, a memory card, a magnetic disk, an optical disc, a magneto-optical disc, a semiconductor memory, and so on can be used as a medium for exchanging data, or for storing settings, etc.

Data-Retrieving Apparatus

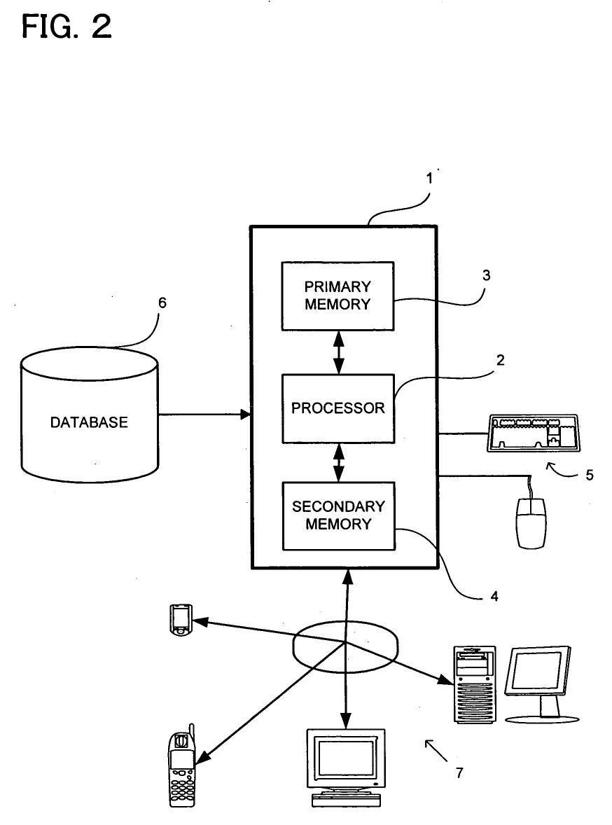

The following description will describe retrieval of the multimedia data as one embodiment according to the present invention with reference to FIG. 2. A general-purpose computer, a special-purpose computer, or the like, can be used as a data-retrieving apparatus 1 shown in FIG. 2. The data-retrieving apparatus 1 includes a processing unit 2, a primary memory portion 3, and a secondary memory portion 4. The processing unit 2 includes a CPU, an MPU, a system LSI, an IC, or the like. The processing unit 2 performs distance calculation between feature vectors, and other necessary arithmetic. The processing unit 2 also plays a role as an extracting portion extracting the maximum value of the distances, an updating portion updating a memory portion by replacing the maximum value with a calculated distance when the calculated distance is less than the maximum value extracted by the extracting portion, and a calculation stopping portion, which determines when to stop the calculation based on a result of the calculation. The processing unit 2 can also be constructed by hardware to perform these processing steps. In addition, the processing unit 2 may be constructed by software to perform these processing steps. The primary memory portion 3 includes a high-speed general-purpose or embedded memory. A semiconductor memory, such as RAM, including SDRAM, DDRRAM, RDRAM, EDORAM, or first page RAM, can be used as the primary memory portion 3. The primary memory portion 3 plays as a memory portion, which retains a predetermined number of distances, which are close to a retrieving query vector, or distances to the retrieving query vector which fall within a predetermined range. A secondary memory portion 4 includes a secondary storage medium, such as a hard disk (fixed disk). A large capacity storage is used as the secondary memory portion 4 compared with the primary memory portion 3. Furthermore, an input portion 5, such as a mouse or a keyboard, is connected to the data-retrieving apparatus 1 if necessary.

A database 6 is a storage medium, which stores data to be retrieved. A large capacity hard disk, etc. can be used as the database 6. Generally, the database 6 is built in or connected to the host computer on the server side. The database 6 is connected to and communicates with the data-retrieving apparatus 1. Moreover, the database 6 may be provided in the data-retrieving apparatus 1. In addition, the secondary memory portion 4 may be used as the database 6. Thus, the connection to the database in the present invention can be applied to either a network connection or a stand-alone connection.

The feature vector can be directly specified by inputting a retrieving condition in order to retrieve the desired data from the database 6. In addition, the feature vector may be transformed into the retrieving condition from an inputted keyword. This transformation is performed in the data-retrieving apparatus 1. Therefore, this does not require a user to be aware of the feature vector.

When the data-retrieving apparatus 1 is applied to the stand-alone computer, the retrieving condition is input by the input portion 5. In addition, when the data-retrieving apparatus 1 is applied to the network, the retrieving condition can be input by the terminals 7, such as a computer in the client side connected to the network, a cellular phone. A LAN, a WAN, the Internet and so on can be used as the network connection. In this case, the data-retrieving apparatus 1 acts as a search engine. The data-retrieving apparatus 1 outputs the result of the retrieval based on the retrieving condition input from each terminal to the apparatus 1.

In this embodiment of the present invention, the processing unit 2 accesses the database 6, and reads data to be retrieved that is stored in the database 6 in the above data-retrieving apparatus 1. The processing unit 2 transforms the data into a multidimensional retrieving vector based on predetermined feature values of the data to be retrieved, and retains this vector in the secondary memory portion 4. On the other hand, similarly, the processing unit 2 transforms the retrieving condition input by the input portion 5 into a retrieving query vector in the same dimension number as the data to be retrieved based on the feature values, and retains this vector in the secondary memory portion 4. Then, a distance between the retrieving query vector and the vector to be retrieved is calculated, and the data with a small distance between them is determined to be similar data. For example, the processing unit 2 sorts the calculated distances, and outputs them in order of the data with a smaller intervector distance as the results of retrieval process.

In addition, it is not always necessary for the data-retrieving apparatus 1 to transform the vector into the vector to be retrieved from the multidimensional data. For example, the vector to be retrieved, which is previously transformed, is stored in the database 6, so that the data-retrieving apparatus 1 can also perform data retrieval by accessing the stored vectors to be retrieved. It is especially effective in the case where the data-retrieving apparatus 1 has a low performance. For example, the server side on the network offers the vectors to be retrieved, for which data conversion is performed, and the data-retrieving apparatus 1 in the client side accesses them. This can reduce a load on the data-retrieving apparatus 1 on the client side.

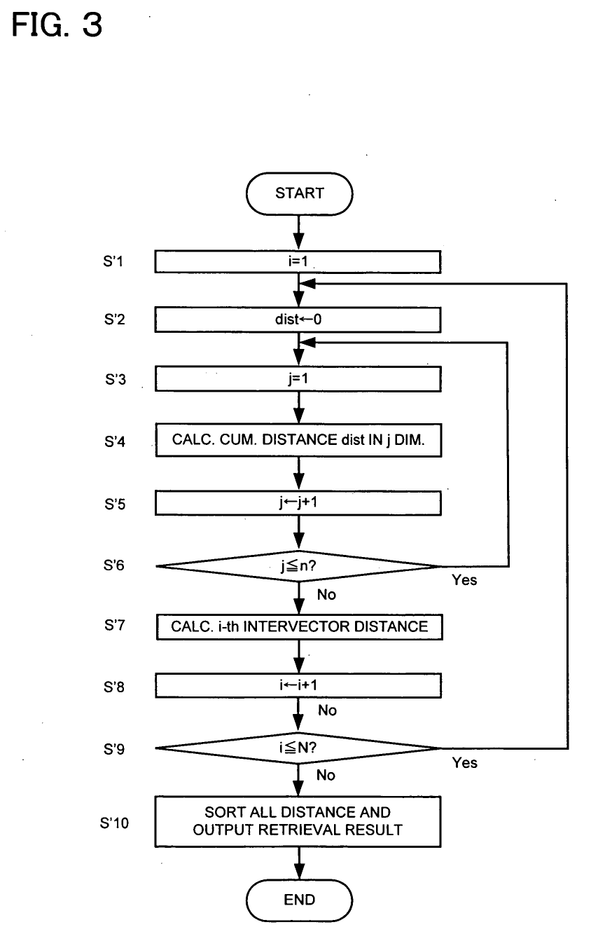

In this embodiment, the amount of calculation decreases sharply by improving the linear retrieving process compared with the conventional data retrieval process. Therefore, the calculation can be performed in a short time. FIG. 3 shows a flowchart of one example of the linear data retrieval process for ease of explanation. In this example, k of similar data are retrieved from N of n-dimensional data to be retrieved. The determination of the similar data is made based on a Euclid distance, which is the square root of the sum of the squares of the differences between the components of the vectors for respective dimensions. The retrieving query vector is represented in the “query” and the i-th vector to be retrieved is represented by “data [i]”.

In step S′1, “i” denoting the number of the vector to be retrieved is initialized. The calculation from the first vector to be retrieved “data [1]” to the N-th vector to be retrieved “data [N]” is performed. In step S′2, a cumulative distance value “dist” between the retrieving query vector and the vectors to be retrieved for the respective dimensions is initialized. In step S′3, “j” denoting the dimension number in a vector is initialized. Thus, the calculation from the value “data [i] [1]” of first dimension of the i-th vector to be retrieved to the value “data [i] [n]” of the n-th dimension is performed.

In step S′4, concrete distances for respective dimensions are calculated. The cumulative distance “dist” of the distances in the j dimensions, in other words the cumulative value of the squares of the respective distances for respective dimensions from the first dimension to the j-th dimension, is calculated. The formula is as follows:
{(value of component for j-th dimension of the retrieving query vector “query [j]”)−(value of component for j-th dimension of the i-th vector to be retrieved “data [i][j]”)} ²

Then, in step S′5, 1 is added to “j”. Subsequently, in step S′6, “j” is compared with n. When “j” is smaller than n, the loop is repeated n times by returning to step S′3. Thus, the square of the distance in n dimensions is calculated by serially adding the square of a distance corresponding to a subsequent component of a vector for a subsequent dimension to a previous cumulative value. In step S′6, when the condition j=n is satisfied, in other words, when n times of the loops are finished, the square root of the cumulative distance “dist” is calculated in step S′7. The Euclid distance “result [i]” of the i-th vector to be retrieved is calculated, and then “result [i]” is retained for respective vectors to be retrieved. In step S′8, 1 is added to “i”. In step S′9, “i” is compared with N. In the case of i[N, the above loop is repeated N times by returning to step S′2. That is, all N vectors to be retrieved are calculated. In step S′10, Euclid distances of the respective vectors to be retrieved “result [1]” to “result [N]” are sorted. These distance are output as the result of the retrieval process starting with data having smaller values.

In the above method, the result of the retrieval process is exactly obtained by calculating all data. On the other hand, this process requires N times of processing for n-dimensional vectors to be retrieved. Therefore, it is necessary to repeat the loop from step S′2 to step S′9 for the process to be completed. Thus, amount of the required calculations is proportional to N×n. Accordingly, this method has a disadvantage that the number of processing steps extremely increases when the number of dimensions of data or the number of data is increased.

In the embodiments of the present invention, an algorithm is used which exactly retrieves and reduces the number of calculations. Concretely, in the calculation of the distance between the vector to be retrieved and the retrieving query vector, when the calculation of data has a large distance that was calculated in a certain dimension, the calculation ends, and then skips to the calculation of a subsequent vector to be retrieved. Thus, unnecessary calculations are eliminated and the processing of the calculations is efficiently performed.

Besides, retrieving k vectors to be retrieved with small distances to the query vector from the database is referred to as the k-nearest neighbor search. Moreover, retrieving vectors to be retrieved within the distance ε to the query vector from the database is referred to as the ε-nearest neighbor search. Both the k-nearest neighbor search and the ε-nearest neighbor search are applicable to the present invention. Hereinafter, the k-nearest neighbor search and the ε-nearest neighbor search are generically referred to as the nearest neighbor search.

### Embodiment 1

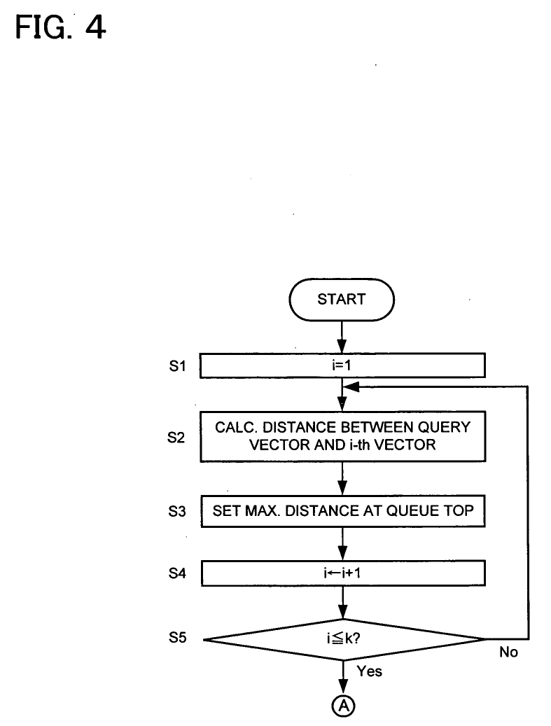

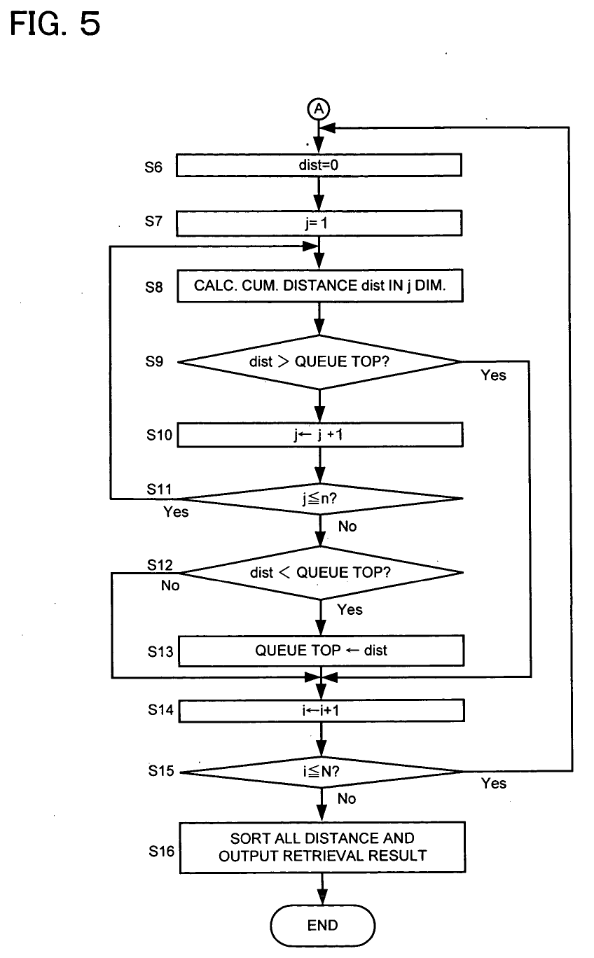

The following description will describe an example of this technique with reference to the flow charts of FIG. 4 and FIG. 5. In this example, the following description will describe the case where k similar data are retrieved from N of the n-dimensional data to be retrieved similar to FIG. 3. In FIG. 4, the first intervector distances between k vectors to be retrieved and a retrieving query vector are calculated. The intervector distances are stored in a priority queue. Then, the maximum distance is stored at the top of the priority queue. The priority queue is provided in the memory space of the primary memory portion 3, and is managed by addressing. In FIG. 5, calculation of the distance for the vector to be retrieved from k+1 is continued. Then, the cumulative distance is compared with the top of the priority queue. When the cumulative distance is larger than the priority queue top, even if subsequent calculation is continued in this case, the vector corresponding to this intervector distance cannot be similar data that will be listed as the result of the retrieval process. Therefore, when the cumulative distance becomes larger than the top of the priority queue, the calculation for this vector ends. Subsequently, the calculation skips to a subsequent vector to be retrieved. In data retrieval, it is not necessary to calculate the distance of such a vector to be retrieved with a large intervector distance, which is not similar to the retrieving query vector. A required amount of calculation can be reduced by eliminating unnecessary calculations, and the data retrieval process can be performed efficiently.

In this embodiment, the priority queue is used in order to detect unnecessary calculations in the distance calculations. The priority queue is an adequate data structure for inserting an element or for deleting the maximum value. In this embodiment, k vectors with small distances to the retrieving query vector are retrieved from N vectors to be retrieved. In this case, the priority queue retains only k distances with small distances to the retrieving query vector from the calculated distances between the retrieving query vectors and vectors to be retrieved. Additionally, in this embodiment, the distance with the maximum value is set at the top of the priority queue in the k distances retained in the priority queue. Further, in this embodiment, in order to achieve the priority queue, heap is used. Besides, other methods for achieving the priority queue, such as list, binominal queue, pairing heap, P-tree, or pagoda, are also applicable to the present invention. The methods for achieving the priority queue including heap have an advantage that an element with the maximum value is easily located at the top, without sorting all of the data. For this reason, in terms of the amount of calculations, the methods for achieving the priority queue result in preferable data structures.

The following description will describe the procedure shown in FIG. 4. In step S1, “i” denoting the number of the vector to be retrieved is initialized. Calculation from the first vector to be retrieved “data [1]” to the N-th vector to be retrieved “data [N]” is performed.

In step S2, the distance between the retrieving query vector and the i-th vector to be retrieved is calculated. Then, the calculated result is inserted in the priority queue. In step S3, the maximum value of the intervector distance is located at the top of the priority queue. In step S4, 1 is added to “i”. In step S5, “i” is compared with k, in step S5. When “i” is not more than k, the loop is repeated k times by returning to step S2. The intervector distances are calculated for k vectors to be retrieved, from the 1st to the k-th vector. Thus, the maximum value in k intervector distances is located at the top of the priority queue. The k intervector distances stored in the priority queue are retained as candidate values of retrieval at this time, in other words, as a temporary result of the retrieval process.

When “i” becomes k, the procedure goes to step S6 shown in FIG. 5 as a configuration from step S5. In step S6, the cumulative distance “dist” between the retrieving query vector and the vector to be retrieved for respective dimensions is initialized. In step S7, “j” denoting the dimension number in a vector is initialized. Then, in step S8, the cumulative distance “dist” between the retrieving query vector and the i-th vector to be retrieved is calculated in the j dimensions. Similarly to the above formula, this formula is
{(value of component for j-th dimension of the retrieving query vector “query [j]”)−(value of component for j-th dimension of the i-th vector to be retrieved “data [i][j]”)} ²

Next, in step S9, this cumulative distance “dist” is compared with the maximum value of the distance located in the top of the priority queue. When the cumulative distance “dist” exceeds the value of the top of the priority queue, the calculation of the distance for the i-th vector to be retrieved stops, and the procedure goes to step S14. Accordingly, since calculation of the distance for the subsequent dimensions is omitted, the amount of processing decreases. On the other hand, when the cumulative distance “dist” is smaller than the top value of the priority queue, the procedure goes to step S10 to continue calculation of the distance, and 1 is added to “j”. In step S11, “j” is compared with “n”. When “j” is not more than “n”, the procedure returns to step S8. By calculating the cumulative distance again, the sum of the square of distances for the first dimension to the n-th dimension, or the square of the Euclid distance, is calculated as the intervector distance “dist”. In addition, in this embodiment, although the calculation of the square root is omitted, the Euclid distance can also be obtained by calculating the square root.

In step S12, the obtained intervector distance “dist ” is compared with the top value of the priority queue. When the intervector distance “dist” of the calculated vector to be retrieved is smaller than the value of the top of the priority queue, in other words, the maximum value in the intervector distances currently retained, the vector to be retrieved is a new candidate having similar data to be retrieved. Therefore, the procedure goes to step S13. The calculated intervector distance “dist” is replaced with the value of the top of the priority queue, and is retained in the priority queue.

On the other hand, when the obtained intervector distance “dist” is more than the top value of the priority queue, the intervector distance “dist” is not the candidate for retrieval. The procedure the jumps to step S14. In step S14, 1 is added to “i”. Subsequently, “i” is compared with N in step S15. In the case of i[N, the above loop is repeated by returning to step S6. Then, all N vectors to be retrieved are calculated. In step S16, when “i” exceeds N, the element in the priority queue is sorted. Then, each vector to be retrieved that was retained in the priority queue is set in order based on the smallest value, and they are output as the result of the retrieval process.

When it becomes clear that the vector to be retrieved is not the candidate of the result of retrieval in the calculation of the distance from step S9 to step S13, the calculation stops, and the procedure goes on to continue the process of searching for the next candidate for retrieval by the above method. Therefore, unnecessary calculations can be eliminated, and the data retrieval process can be performed efficiently. Moreover, in this method, one sorting of the elements in the priority queue is only required at the end of the procedure. Since the priority queue is partially corrected during the calculation progress, the load of the calculations can be reduced.

Furthermore, in the above method, many calculations can be reduced by detecting unnecessary calculations in the early stage of the process. Accordingly, the process can be more efficient and can be performed at a higher speed. The techniques of the following embodiments 2 and 3 can apply as a preprocessing stage, which can detect unnecessary calculations at an early stage.

### Embodiment 2

### Dimension Sort by Variance Value

In the method of embodiment 2, before the intervector distance is calculated, the components of the vector are previously sorted based on variance values of the components of each dimension in the vector to be retrieved. The intervector distances are calculated in order based on dimensions with the largest to smallest variance values. In this method, the variance value is calculated for each dimension in N of the n-dimensional vectors to be retrieved. Then, the dimensions are sorted in order of higher variance values, and are arranged corresponding to that order. Thus, the dimension with a large variance value is calculated first. Accordingly, it is expected that the cumulative distance tends to become large early in the calculation process. Therefore, there is a high possibility that subsequent calculation is skipped.

### Embodiment 3

### Data Conversion by Principal Component Analysis

In the method of embodiment 3, before the intervector distance is calculated, a coordinate system of the vector to be retrieved is previously transformed based on a principal component analysis, and the intervector distance is calculated based on the vector transformed into this coordinate system. The principal component analysis is also referred to as a KL transform (Karhunen-Loeve transform). The principal component analysis can provide a coordinate system, which most remarkably represents variation in the multidimensional data. In the principal component analysis, eigenvectors become new axes of coordinates by resolving the covariance matrix of the multidimensional data into eigenvalues. In this case, when the eigenvalue of the eigenvector of the coordinate axis is high, the variance of the data is also high. Each component is referred to as a first principal component, a second principal component, in order of the eigenvector with a higher eigenvalue. First, the previously transformed data is ordered based on the coordinate value for the 1st principal component and then the coordinate value for the 2nd principal component. When the intervector distance is calculated, there is a high possibility that subsequent calculations are skipped. Moreover, the principal component analysis also has an advantage that the new coordinate value is easily calculated by projecting the new data on each principal component, even if the new data is added.

In any of the above methods, the data transformation of the vector to be retrieved is performed as a preprocessing process before calculating the intervector distance. This data transformation takes time. The data transformation using principal component analysis especially needs more processing time compared to the dimension sort using the variance values. However, since these processes can be performed before data retrieval is actually performed, the processes are independent of the time required for the data retrieval process. Thus the actual time for the practical data retrieval can be reduced by preprocessing the data and storing the result.

Besides, in this embodiment, the principal component analysis (KL transform) is used as the data transformation method. However, an orthogonal transform, such as a wavelet transform, a Fourier transform, the Walsh-Hadamard transform, a discrete cosine transform, or the discrete sine transform, can be used instead of the KL transform.

Result of Measurement

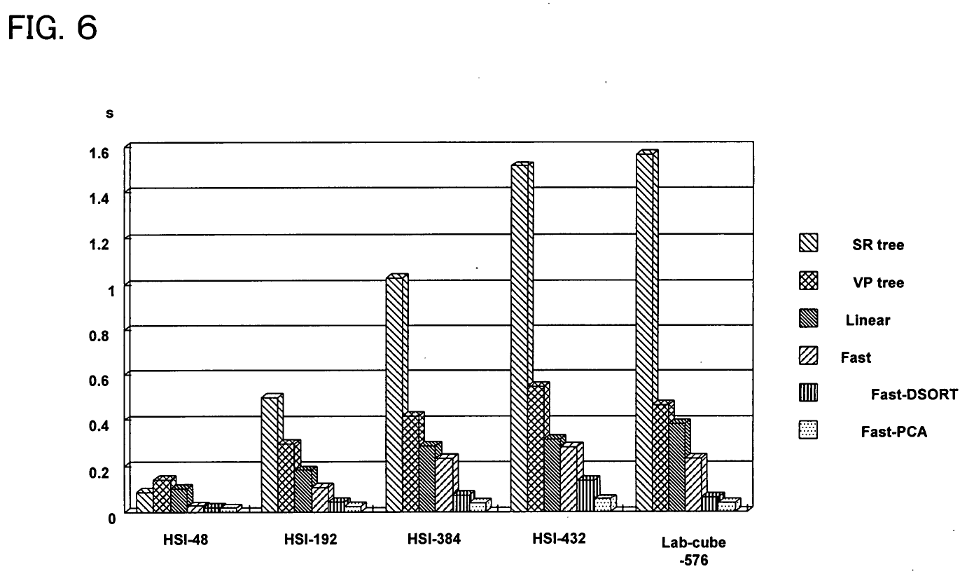

Table 1 and FIG. 6 show the results of the processing time necessary for retrieval of one query measured in using the above mentioned data retrieval method. In this example, 50,000 image data are used in the database. Only color information in the HSI color system is extracted from the image data as its feature values. A whole picture is divided into 3×3 HSI regions. The HSI feature values for each region are compressed into a 48-dimensional, a 192-dimensional, a 384-dimensional, and a 432 dimensional vector to be retrieved. Additionally, in Lab-cube-576, the whole picture is uniformly divided into 3×3 regions in the vertical and the horizontal directions. After the color information of each whole picture is transformed into the Lab color system, the Lab space is divided into 4×4×4=64 subspaces for each whole picture. In Lab-cube-576, the frequency value of the pixels corresponding to each subspace was calculated. Based on this calculation, 64×9=576 dimensions of feature values are obtained for the whole picture.

A computer with a 2.4 GHz Pentium (registered trademark)-IV CPU and 1024 kB memory is used as the apparatus for retrieving data. Moreover, for methods of retrieving data, three methods of the embodiments according to the present invention and three methods as comparative examples are used. SR-tree, which is a multidimensional indexing technique in Euclidean space; VP-tree, which is a indexing technique for more general metric space; and Linear, which is linear retrieval, are used as the comparative examples. A public program for the SR-tree method is used. The SR-tree method is often used as a baseline for comparing a retrieving techniques. Additionally, in the embodiments of the present invention, a Fast process performing calculation of the intervector distance and calculation skip, a Fast-DSORT process combining dimension sorting by the variance value with the above Fast process, and a Fast-PCA process combining the data transformation by the principal component analysis with the above Fast process are used in embodiment 1, embodiment 2, and embodiment 3, respectively. In FIG. 6, the horizontal axis shows types of vectors to be retrieved, and the vertical axis shows the processing time of CPU, respectively. The bar graph shows the following processes from the left side, respectively: SR-tree, VP-tree, Linear, Fast, Fast-DSORT, and Fast-PCA.

TABLE 1

| | HSI-48 | HSI-192 | HSI-384 | HSI-432 | cube-576 |
|---|---|---|---|---|---|
| SR tree | 0.087 | 0.501 | 1.027 | 1.515 | 1.564 |
| VP tree | 0.143 | 0.294 | 0.416 | 0.546 | 0.466 |
| Linear | 0.102 | 0.182 | 0.286 | 0.313 | 0.382 |
| Fast | 0.027 | 0.109 | 0.231 | 0.28 | 0.232 |
| Fast-DSORT | 0.02 | 0.046 | 0.074 | 0.134 | 0.061 |
| Fast-PCA | 0.017 | 0.026 | 0.039 | 0.056 | 0.037 |

As shown in FIG. 6, it can be seen that the methods for retrieving data of the embodiments of the present invention are high speed for any feature values of the vectors to be retrieved. The differences are remarkable especially in high dimensions. For example, in the case of a 48-dimensional feature vector (HSI), the calculation times were 0.027 s in the Fast process, 0.02 s in the Fast-DSORT process, and 0.017 s in the Fast-PCA process, respectively, and this compares with 0.087 s in the SR-tree process which is a reference speed. The processing speeds improved 4.71 times, 4.00 times, and 2.96 times higher, respectively, when compared with the time required using the SR-tree process as reference for the retrieving speed. In the case of a higher dimension, the 576-dimensional feature Vector (Lab-cube), calculation times were 0.232 s in Fast, 0.061 s in the Fast-DSORT process, and 0.037 s in the Fast-PCA process, respectively, when compared with 1.564 s in the SR-tree process. The processing speeds improved 42.27 times, 25.64 times, and 6.74 times higher, respectively. Thus, the effect on the speed improvement was remarkable especially in high dimensions.

Moreover, the methods of the embodiments of the present invention were also effective in terms of improving the speed of the linear retrieval process. In the case of a low dimension 48-dimensional vector (HSI), the processing speeds were 3.78 times in the in Fast, 5.1 times in the Fast-DSORT process, and 6 times higher in the Fast-PCA process as compared with 0.102 s in the Linear process. In the case of a high dimension 576-dimensional vector (Lab-cube), the processing speeds were 1.65 times in the Fast process, 6.6 times in the Fast-DSORT process, and 10.32 times higher in the Fast-PCA process as compared with 0.382 s in the Linear process. Conventionally, linear retrieving was considered unsuitable for a low-speed computer especially in a high dimension. However, it is possible to retrieve at a high speed and exactly obtain a result of the retrieval process in practice by applying the embodiment of the present invention.

As mentioned above, it was confirmed that the methods for retrieving data with the embodiments of the present invention allow retrieval at a remarkably high speed when compared not only with the simple linear retrieval process but also with the VP-tree and SR-tree processes, which are conventional techniques for multi-dimensional vector retrieval. Moreover, according to this invention, it was confirmed that the embodiment 2 was superior to the embodiment 1, and the embodiment 3 was superior to the embodiment 2. Especially, the preprocessing of the data transformation by the principal component analysis of embodiment 3 provided the highest-speed for retrieval.

In the above embodiments, it is explained that retrieval of the present invention can be applied to a method for retrieving data by linear retrieval. However the retrieval process of the present invention is applicable not only to the linear retrieval process but also to calculations of tree structures, such as the SR-tree. Calculation of the tree structure is a calculation method that calculates all data as well as linear retrieval. Therefore, the amount of calculation increases by increasing the number of data, so that calculation of the tree structure is considered unsuitable. However, the amount of calculation is reduced by applying the present invention, and thus it is possible to achieve an improvement in speed.

In addition, the various kinds of distances are applicable as a scale of the intervector distance. In the above embodiments, the Euclid distance is used, however the present invention is not specifically limited to this distance. For example, distances, such as Lp norm, the Minkowski distance, can be used as a scale of the intervector distance. In the case of p=2 for the Lp norm, it is equivalent to the Euclid distance. Additionally, in the present invention, when the distance between the vectors is calculated, the distance is calculated by sequentially adding for each dimension of the vector. This is immediately applicable also in the general Lp norm. Moreover, a cosine distance, an inner product, a weighted Euclid distance, an ellipsoid distance, and a Mahalanobis distance, or the like, can be used as distance scales other than mentioned above. The present invention is also suitably applicable to these distance scales.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within meets and bounds of the claims, or equivalence of such metes and bounds thereof are therefore intended to be embraced by the claims.

This application is based on Japanese Patent Application No. 2003-174078 filed on Jun. 18, 2003, the content of which is incorporated hereinto by reference.

1. A method for retrieving data from multidimensional data, comprising the steps of:
providing a plurality of vectors having feature values in the multidimensional data;
transforming a specified retrieving condition into a retrieving query vector having a dimension equal to a dimension of the multidimensional data;
calculating distances between the retrieving query vector and potential vectors to be retrieved, said step of calculating distances includes calculating a distance between the retrieving query vector and a potential vector to be retrieved by serially adding a value corresponding to a subsequent component of each vector for a subsequent dimension to a cumulative value when the cumulative value is less than the maximum value;
stopping said step of serially adding a value and skipping said step of calculating a distance when the cumulative value is greater than the maximum value;
retaining the distance calculated in said step of calculating when the cumulative value is less than the maximum value;
replacing the maximum value with the distance calculated in said step of calculating, when the distance is less than the maximum value; and
outputting the multidimensional data retained in said step of retaining the distance after said steps of retaining and replacing.

2. The method for retrieving data according to claim 1, further comprising the step of:
sorting components of the potential vectors to be retrieved based on variance values of the components of the potential vectors to be retrieved for respective dimensions before said step of calculating a distance,
wherein said step of calculating a distance starts by adding a component of the dimension having a greater variance value.

3. The method for retrieving data according to claim 1, further comprising the step of:
transforming a coordinate system of a vector before said step of calculating a distance,
wherein said step of calculating a distance uses the vector obtained in said step of transforming.

4. The method for retrieving data according to claim 1, wherein said step of providing a plurality of vectors includes storing the plurality of vectors in at least one of a local database and a database connected to a network; and
said steps of calculating and retaining use the data in at least one of the local database and a database connected to the network.

5. The method for retrieving data according to claim 1, wherein the data includes at least one of document data, voice data, music data and image data which includes at least one of a still image and a video image.

6. The method for retrieving data according to claim 1, wherein said method includes recognizing an image pattern.

7. A method for retrieving related data from multidimensional data, comprising the steps of:
providing a plurality of vectors having feature values in the multidimensional data;
transforming a specified retrieving condition into a retrieving query vector having a dimension equal to a dimension of the multidimensional data;
calculating distances between the retrieving query vector and potential vectors to be retrieved, said step of calculating distances includes calculating a distance between the retrieving query vector and a potential vector to be retrieved by serially adding a value corresponding to a subsequent component of each vector for a subsequent dimension to a cumulative value when the cumulative value is less than a maximum value;
stopping said step of serially adding a value and skipping said step of calculating a distance when the cumulative value is greater than the maximum value;
retaining the distance calculated in said step of calculating when the cumulative value is less than the maximum value;
replacing the maximum value with the distance calculated in said step of calculating, when the distance is less than the maximum value; and
outputting the multidimensional data retained in said step of retaining the distance.

8. The method for retrieving data according to claim 7, further comprising the step of:
sorting components of the potential vectors to be retrieved based on variance values of the components of the potential vectors to be retrieved for respective dimensions before said step of calculating a distance,
wherein said step of calculating a distance starts by adding a component of the dimension having a greater variance value.

9. The method for retrieving data according to claim 7, further comprising the step of:
transforming a coordinate system of a vector before said step of calculating a distance,
wherein said step of calculating a distance uses the vector obtained in said step of transforming.

10. The method for retrieving data according to claim 7, wherein said step of providing a plurality of vectors includes sorting a plurality of vectors in at least one of a local database and a database connected to a network; and
said steps of calculating and retaining use the data in at least one of the local database and the database connected to a network.

11. The method for retrieving data according to claim 7, wherein the data includes at least one of document data, voice data, music data and image data which includes at least one of a still image and a video image.

12. The method for retrieving data according to claim 7, wherein said method includes recognizing an image pattern.

13. An apparatus for retrieving data from a database having multidimensional data including a plurality of vectors having feature values, comprising:
an input portion for specifying a retrieving condition for retrieving data from the database storing the multidimensional data and for transforming the retrieving condition into a retrieving query vector having a dimension equal to a dimension of the multidimensional data;
a calculating portion for calculating a distance between the retrieving query vector and a potential vector to be retrieved by serially adding a value corresponding to a subsequent component of each vector for a subsequent dimension to a cumulative value;
a memory portion for retaining a plurality of distances calculated by said calculating portion;
an extracting portion for extracting a maximum value of the plurality of the distances retained by said memory portion;
an updating portion for updating said memory portion by replacing the maximum value with the distance calculated by said calculating portion when the calculated distance is less than the maximum value extracted by said extracting portion; and
a calculation stopping portion for comparing the cumulative value with the maximum value during calculating the distance between the retrieving query vector and the potential vectors to be retrieved by serially adding a value corresponding to a subsequent component of each vector for a subsequent dimension to the cumulative value, said calculation stopping portion stopping the addition of the subsequent component of the vector and skipping a calculation of the distance of a subsequent component of the vector, when the cumulative value is greater than the maximum value.

14. The apparatus for retrieving data according to claim 13, wherein said calculating portion sorts components of the potential vectors,to be retrieved based on variance values of the components of the vectors to be retrieved for respective dimensions, before calculating the distance between the retrieving query vector and each potential vector to be retrieved, said calculating portion calculates the cumulative value by adding a component for the dimension with a greater variance value.

15. The apparatus for retrieving data according to claim 13, wherein said calculating portion includes a means for transforming a coordinate system of a vector before calculating the distance between the retrieving query vector and the potential vectors to be retrieved.

16. The apparatus for retrieving data according to claim 13, further comprising a medium readable by a machine.

17. A program for retrieving data from a database having multidimensional data including a plurality of vectors having feature values, comprising:
means for transforming a specified retrieving condition into a retrieving query vector having a dimension equal to a dimension of the multidimensional data;
means for calculating distances between the retrieving query vector and potential vectors to be retrieved including means for calculating a distance between the retrieving query vector and a potential vector to be retrieved by serially adding a value corresponding to a subsequent component of each vector for a subsequent dimension to a cumulative value when the cumulative value is less than a maximum value;
means for stopping said means for calculating and skipping calculating a distance when the cumulative value is greater than the maximum value;
means for retaining the distance calculated by said means for calculating when the cumulative value is less than the maximum value;
means for replacing the maximum value with the calculated distance for the potential vector to be retrieved when the distance is less than the maximum value; and
means for outputting the multidimensional data retained in said means for retaining.

18. A program for retrieving data according to claim 17, wherein said means for retaining the distance includes means for retaining the distance when the distance is within a predetermined range.
